(19) United States
(12) Patent Application Publication
(10) Pub. No.: US 2007/0259692 A1
(43) Pub. Date: Nov. 8, 2007

(54) Radio resource management architectures for internet protocol based radio access networks with radio resource control in base stations

(76) Inventor: Muthaiah Venkatachalam, Beaverton, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/431,934

(22) Filed: May 9, 2006

Related U.S. Application Data
(63) Continuation-in-part of application No. 11/405,930, filed on Apr. 17, 2006.

(51) Int. Cl. H04B 1/38; H04M 1/00

(52) U.S. Cl. 455/560

(57) ABSTRACT

Embodiments of the present invention provide methods and apparatus for radio resource management (RRM) architecture for Internet Protocol (IP) based radio access networks. Other embodiments may be described and claimed.

### CROSS REFERENCE TO RELATED APPLICATIONS

The present application is a continuation-in-part of and claims priority to U.S. patent application Ser. No. 11/405,390, filed Apr. 17, 2006, entitled “METHODS AND APPARATUS FOR RESOURCE MANAGEMENT ARCHITECTURES FOR INTERNET PROTOCOL BASED RADIO ACCESS NETWORKS,” the entire contents of which is hereby incorporated by reference in its entirety.

### TECHNICAL FIELD

Embodiments of the present invention relate to the field of wireless networks, and more specifically, to methods and apparatus for radio resource management (RRM) architectures for Internet Protocol (IP) based radio access networks.

### BACKGROUND

Radio resource management in IP based radio access networks involves procedures that provide decision support for IP based radio access networks, such as, for example, Worldwide Interoperability for Microwave Access (WiMAX) networks, and their associated functions. Some of these functions include, for example, mobile client admission control, i.e., ascertaining that required radio resources are available at a potential target base station (BS) before handover (HO) of service; service flow admission control, i.e., creation or modification of existing/additional service flows for an existing MS in the network; selection of values for admitted and active quality of service (QoS) parameter sets for service flows; load control, which manages situations where system load exceeds the threshold and some counter-measures need to be taken to get the system back to feasible load; and HO preparation and control for improvement and maintenance of overall performance indicators (for example, RRM may assist in system load balancing by facilitating selection of the most suitable base station during a HO of service).

### BRIEF DESCRIPTION OF THE DRAWINGS

Embodiments of the present invention will be readily understood by the following detailed description in conjunction with the accompanying drawings. To facilitate this description, like reference numerals designate like structural elements. Embodiments of the invention are illustrated by way of example and not by way of limitation in the figures of the accompanying drawings.

FIG. 1 is a schematic diagram of exemplary Internet Protocol (IP) based radio access networks incorporated with the teachings of the present invention, in accordance with various embodiments;

FIG. 2 is a schematic diagram of exemplary RRM architecture for access service networks incorporated with the teachings of the present invention, in accordance with various embodiments;

FIG. 3 is a schematic diagram of exemplary RRM architecture for access service networks incorporated with the teachings of the present invention, in accordance with various embodiments;

FIG. 4 is a schematic diagram of exemplary RRM architecture for access service networks incorporated with the teachings of the present invention, in accordance with various embodiments; and

FIG. 5 is a block diagram representation of an example processor system that may be used to practice various aspects of the present invention.

### DETAILED DESCRIPTION OF EMBODIMENTS OF THE INVENTION

In the following detailed description, reference is made to the accompanying drawings which form a part hereof wherein like numerals designate like parts throughout, and in which is shown by way of illustration embodiments in which the invention may be practiced. It is to be understood that other embodiments may be utilized and structural or logical changes may be made without departing from the scope of the present invention. Therefore, the following detailed description is not to be taken in a limiting sense, and the scope of embodiments in accordance with the present invention is defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

For the purposes of the present invention, the phrase “A/B” means A or B. For the purposes of the present invention, the phrase “A and/or B” means “(A), (B), or (A and B)”. For the purposes of the present invention, the phrase “at least one of A, B, and C” means “(A), (B), (C), (A and B), (A and C), (B and C), or (A, B and C)”. For the purposes of the present invention, the phrase “(A)B” means “(B) or (AB)” that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

Embodiments of the present invention provide methods and apparatus for efficient radio resource management (RRM) architecture for Internet Protocol (IP) based radio access networks. The methods and systems described herein are not limited in this regard.

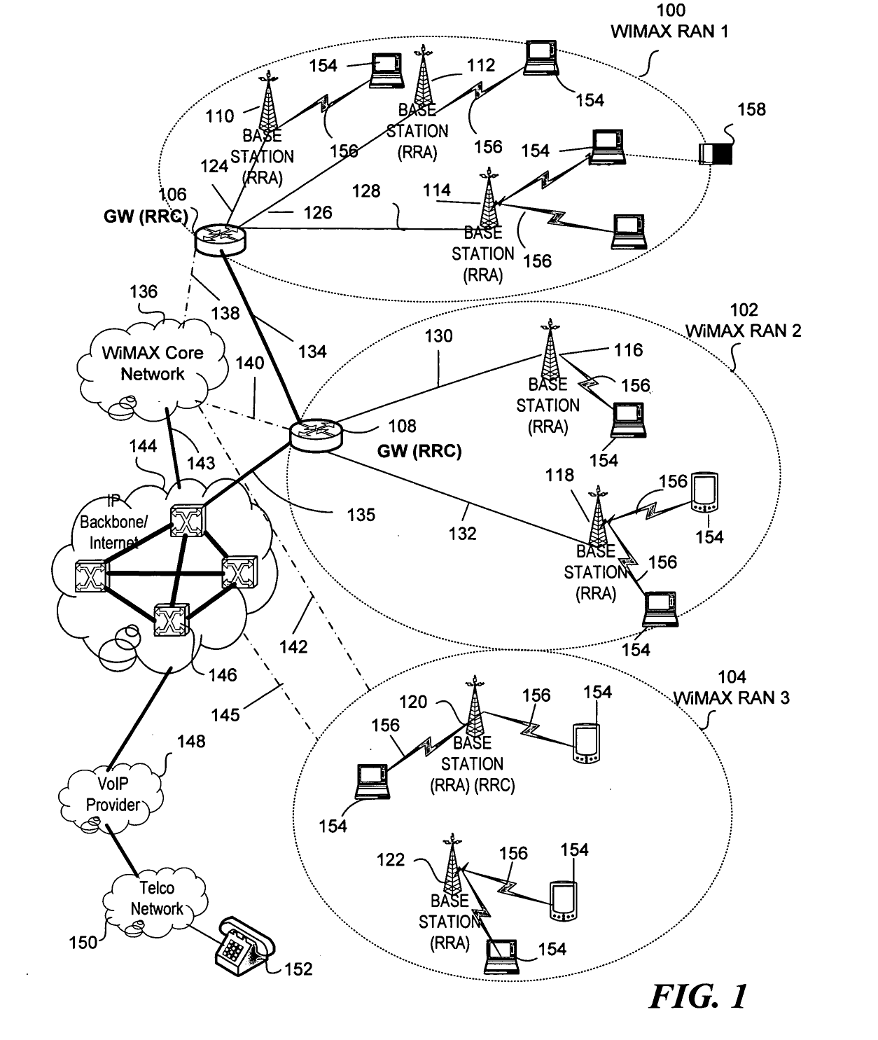

To provide a clear and understandable description of embodiments of the present invention, a brief description of Internet Protocol (IP) based radio access networks (RANs) is provided below. Additionally, examples of methods and apparatus for RRM architectures are described with reference to RANs. It should be understood that principles and techniques of embodiments of the present invention may be employed for RRM architectures of RAN networks such as, for example but not limited to, Worldwide Interoperability Microwave Access (WiMAX) networks, Wireless Fidelity (Wi-Fi) networks, Third Generation (3G) cellular networks and Ultra-wideband (UWB) networks. The IP based RANs of FIG. 1 are illustrated and described as WiMAX RANs for simplicity. Additionally, although some of the examples are described with respect to standards developed by Institute of Electrical and Electronic Engineers (IEEE), the methods and systems disclosed herein are not so limited, and are readily applicable to many specifications and/or standards developed by other special interest groups and/or standard development organizations (e.g., Wireless Fidelity (Wi-Fi) Alliance, Worldwide Interoperability for Microwave Access (WiMAX) Forum, Infrared Data Association (IrDA), Third Generation Partnership Project (3GPP), Ultra-wideband (UWB) Forum, etc.).

FIG. 1 illustrates simplified exemplary IP based RANs incorporated with the teachings of the present invention in accordance with various embodiments and Radio Resource Management (RRM) architecture. A first WiMAX RAN 1 (100) is illustrated that includes a gateway (GW) 106 communicatively coupled to base stations 110, 112 and 114 via links 124, 126 and 128, respectively. A second WiMAX RAN 2 (102) is illustrated that includes a GW 108 communicatively coupled to base stations (BS) 116 and 118 via links 130 and 132, respectively. Each GW includes an omnidirectional antenna (not shown). A third WiMAX RAN 3 (104) is illustrated that does not include a gateway but does include two base stations 120 and 122.

Each base station includes an RRM component in the form of a radio resource agent (RRA). RANs 100, 102 and 104 also include another RRM component in the form of at least one radio resource controller (RRC), which may reside in a base station or in a GW depending upon the RAN deployment profile. Thus, in the exemplary embodiment illustrated in FIG. 1, RANs 100 and 102 include a RRC within their GWs 106 and 108, respectively, while RAN 104 includes its RRC within base station 120. In addition, each RAN may include multiple gateways.

In one example, mobile client devices (MCD) 154 access the networks (via an appropriate base station) using the Physical Layer (PHY) and Media Access Control Layer (MAC) features defined by the IEEE 802.16 family of standards (e.g., the IEEE std. 802.16-2004, published Sep. 18, 2004; the IEEE std. 802.16e, published Feb. 28, 2006; etc.). Exemplary MCDs include notebook computers and hand-held wireless devices (e.g., personal digital assistants (PDAs), pocket PCs, cellular phones supporting 802.16 links, etc.).

To support station-side operations, each MCD 154 provides an appropriate RAN interface, such as depicted by a PCMCIA card 158 for a notebook computer. Optionally, the RAN wireless interface may be built into the MCD 154. Each MCD is illustrated communicatively coupled to a base station via a link 156.

In general, an MCD 154 may access a RAN via some form of subscription service offered by a RAN service provider, although some RAN services might be provided free of charge, e.g., University campus, city coverage, etc. As such, GWs 106 and 108 are depicted as being communicatively coupled to and managed by a WiMAX core network 136 via links 138 and 140, respectively. Additionally, GWs 106 and 108 may be communicatively coupled to one another as depicted by link 134. RAN 104 is communicatively coupled to the WiMAX core network via its base stations 120 and 122 as depicted by link 142. It will be understood that the coupling between a given GW and WiMAX core network 136 may be via a dedicated link (e.g., private trunk or the like), or through another communication means, such as via IP backbone network 144, which includes multiple network elements 146 (e.g., backbone switches and routers), as depicted by links 135 and 145. WiMAX core network 136 is communicatively coupled to IP backbone network 144 via link 143.

A Voice over IP (VoIP) provider 148 is illustrated communicatively coupled to IP backbone 144 to enable phone calls to be carried over Internet infrastructure using a packetized transport. For illustrative purposes, the VoIP facilities depicted in FIG. 1 is represented by a VoIP provider network 148, a telecommunications (telco) network 150, and a telephone 152 (or other suitable device such as, for example, desktop computer, notebook computer and hand-held wireless devices (e.g., personal digital assistants (PDAs), pocket PCs, cellular phones)).

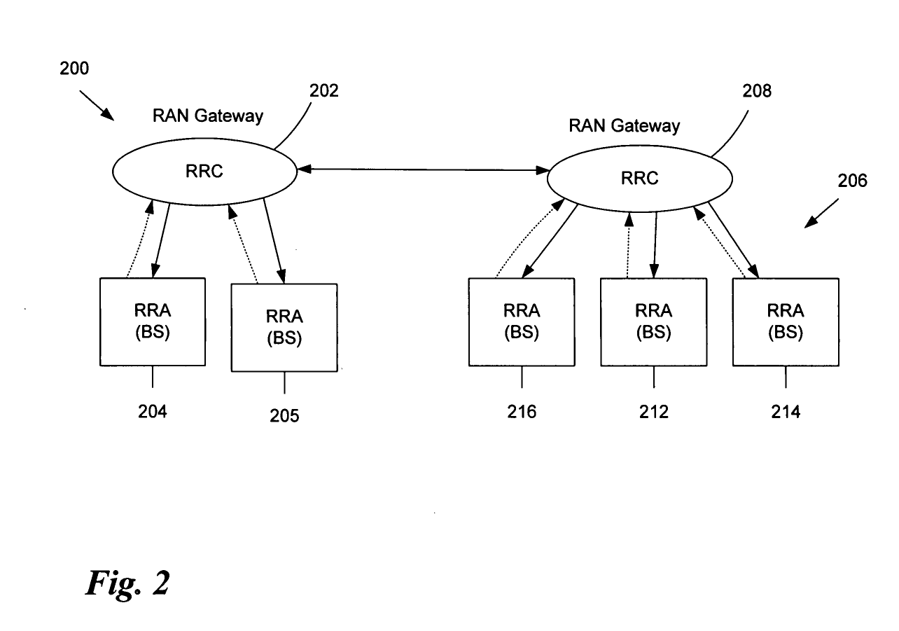

FIG. 2 schematically illustrates general RRM architecture for RANs that incorporates the teachings of the present invention in accordance with various embodiments. As may be seen, a first RAN 200 includes an RRC 202 within a RAN gateway and RRAs 204, 205 within RAN base stations (BS). A second RAN 206 includes RRC 208 within a RAN gateway and RRAs 210, 212 and 214 within RAN base stations (BS). RRC 202 communicates with RRC 208 and RRAs 204, 205 of its own RAN. RRC 208 communicates with RRC 202 and RRAs 210, 212 and 214. The interfaces over which the RRM messages are sent are IP based.

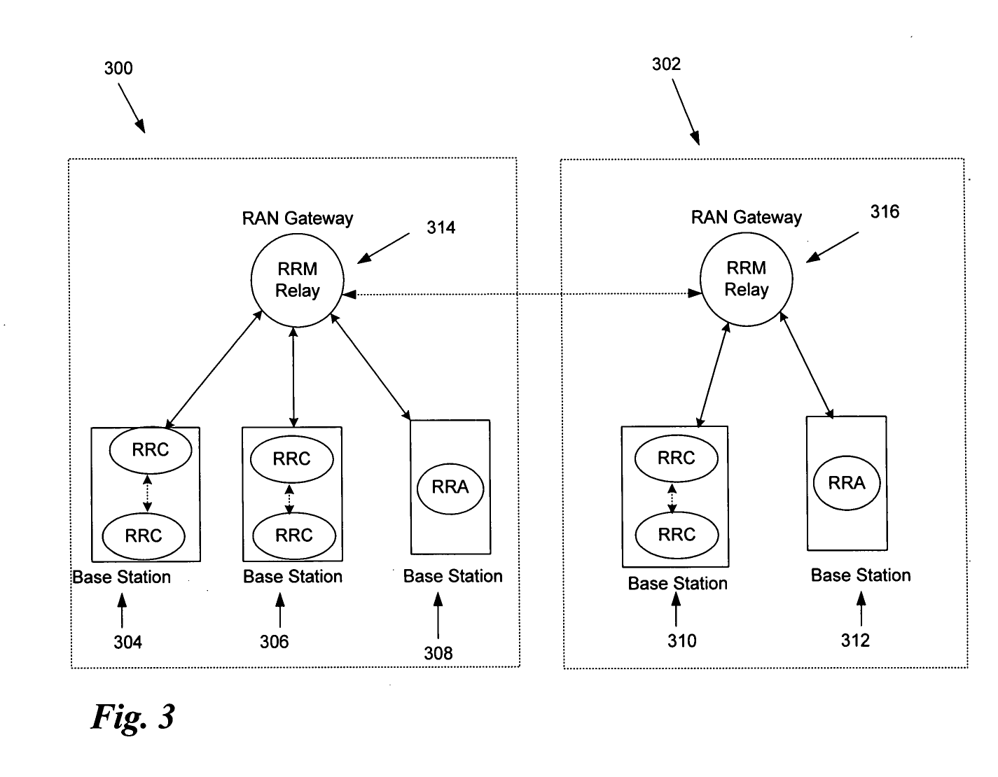

FIG. 3 schematically illustrates exemplary RANs 300 and 302 in accordance with various embodiments of the present invention, wherein RRCs are included within at least one base station. RAN 300 includes base stations 304, 306 and 308, while RAN 302 includes base stations 310 and 312. Gateways 314 and 316 are also included within RANs 300 and 302, respectively. As may be seen, in this embodiment, base stations 302, 304 and 312 each include an RRC and RRA, while base stations 306 and 310 each include an RRA. Gateways 314 and 316 each include an RRM relay. Those skilled in the art will understand that a different number of base stations may be included in the networks if desired, each of which may include an RRC and/or an RRA. Additionally, each network may include more than one gateway, each of which will include an RRM relay in this exemplary embodiment.

With RRAs and RRCs co-located within some base stations, the RRM relay is provided within a gateway of the RAN in order to facilitate the RRC to RRC and RRC to RRA communications within and between RANs over standard reference interfaces. With such a model, RRM primitives may be supported in an effective manner between the RRCs and the RRAs, both intra- and inter-RAN when an RRC and an RRA are co-located in base stations, and when only an RRA is located within a base station.

For example, when RRC in base station 304 is going to communicate with RRC in base station 306 within RAN Network 300, the RRC within base station 304 will communicate with the RRM relay within gateway 314, which will pass along the communication to the RRC within base station 306. Likewise, if the RRC within base station 304 wishes to communicate with the RRA within base station 308, the RRC will communicate with the RRM relay within gateway 314, which will pass along the communication to the RRA. If the RRC within base station 304 wishes to communicate with an RRC or RRA in RAN 302, then the RRC within base station 304 will communicate with the RRM relay within gateway 314, which passes along the communication to the RRM relay within gateway 316, which passes along the communication to either the RRC within base station 312 (which may pass on the communication to the RRA within the base station 312 if necessary) or the RRA within base station 310. Likewise, if an RRA wishes to communicate with an RRC or another RRA, the RRA communicates with an appropriate RRC or RRM relay, which passes on the communication down the line as appropriate.

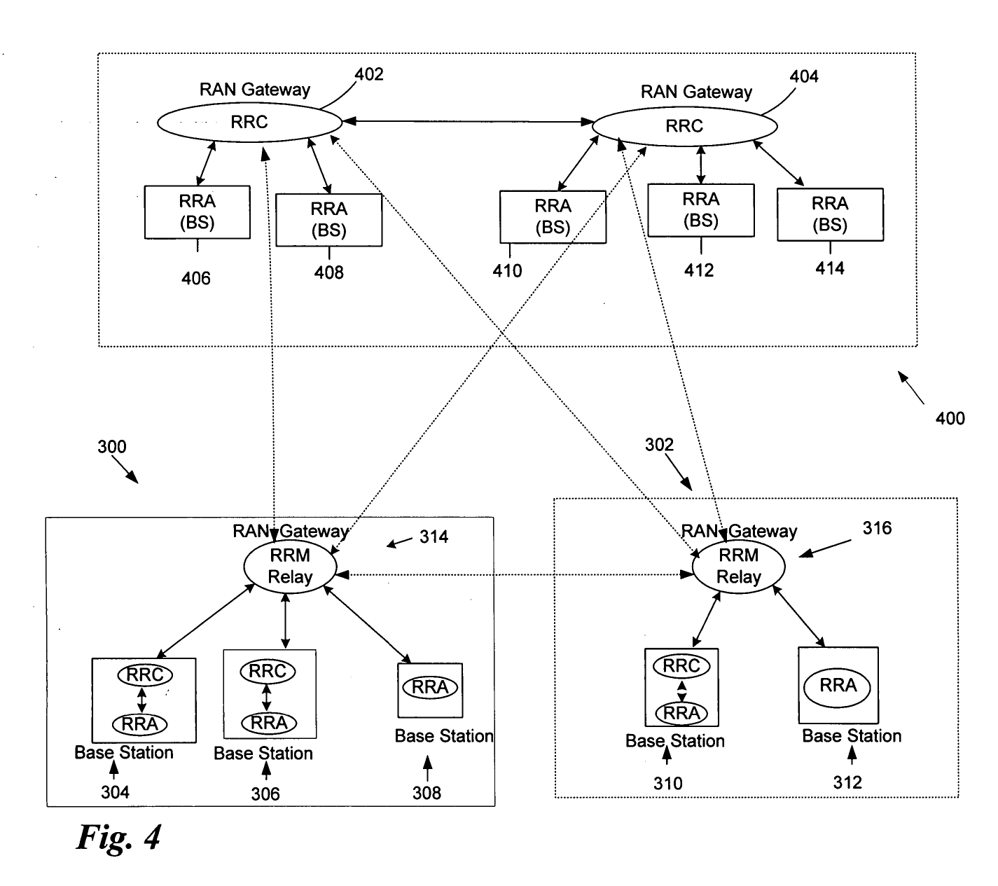

Turning to FIG. 4, RAN 400 includes RAN gateways 402 and 404 as well as base stations 406, 408, 410, 412 and 414. RAN 400 is organized in a manner similar to the network illustrated in FIG. 2 and thus, RAN gateways 402 and 404 include RRCs, while base stations 406, 408, 410, 412 and 414 include RRAs. If RAN 300 or 302 wish to communicate with RAN 400, then the appropriate RRM relay within gateway 314 or 316 will communicate with the appropriate RRC within either RAN gateway 402 or RAN gateway 404. The communication may be direct or indirect, i.e., the RRM relay may communicate with gateway 402, which passes the communication to gateway 404.

Communications received from the RRM relays at the RAN gateways 402 and 404 are passed to the base stations as appropriate. For example, if the RRC within base station 310 wishes to communicate with the RRA in base station 406, the RRC in base station 310 will communicate with the RRM relay in RAN gateway 316, which will communicate with the RRC in RAN gateway 402, which will communicate with the RRA in base station 406. Likewise, if an RRM component in RAN 400 wishes to communicate with an RRM component in RANs 300 or 302, the RRM component in RAN 400 communicates with an appropriate RRC or appropriate RRM relay as illustrated in FIG. 4, which passes on the communication down the line as appropriate.

Examples of key message primitives for RANs include a “base station spare capacity request,” which is sent to the base station from which the spare capacity report is needed and a “Per-base station spare capacity report,” which is sent in response to a “base station spare capacity request.” These reports are indexed by each base station's identification (ID) and indicate the radio resources available at the particular base station, e.g. as a tool for base station selection during network entry or handover. Such reporting may be solicited or unsolicited. Such reports are sent from RRA to RRC, as well as between RRCs such that all interested RRCs may have information on current spare capacity of the base stations for which they are responsible, or, of neighboring base stations in other RANs.

Other primitives include a “Per MCD physical (PHY) layer report” request, which relates to, for example, a request for the radio resources used by the service flows currently active in the MCD and is requested by any base station from the base station serving an MCD, and a “Per MCD PHY report response,” which is the response to the “Per MCD PHY layer report” and is sent from the base station serving the MCD to the requesting base station.

Another primitive includes a “base station radio resource status update,” which is generated from RRC to RRA to propose a change of a broadcasted “neighbor advertisement message” on the airlink (for handover purposes) from this base station based on the load from neighboring base stations.

The contents of a “base station spare capacity request” may be used at the time of handoff of service for an MCD before the handoff occurs. The base station currently serving the MCD may request this report from some or all of the base stations in a neighbor list of base stations. A neighbor list generally identifies base stations that are neighbors to a particular base station for various purposes such as, for example, handover of service. Additionally, a “Per MCD PHY report response” may be sent in an unsolicited manner from the base station serving the MCD to all the other base stations in the neighbor list during handover preparation or it may be sent from the serving base station to a target base station in response to a “Per MCD physical (PHY) layer report” from the target base station (once the target base station is chosen for handover of service). The contents of a “Per MCD PHY report response” may be used to prune the neighbor list before the neighbor advertisement message is sent on the airlink. This may be sent from an RRC located in the network gateway or a base station to all or some of the base stations in the network.

Many of the RRM messages described above are intended for multiple recipients. A beneficial manner for delivery of the messages intended for multiple recipients (with minimal message copy transmissions) is to use Internet protocol (IP) multicasting. IP multicasting techniques are used to provide communication between radio resource controllers (e.g., gateways) and radio resource agents (e.g., base stations) in a network. IP multicasting involves sending a single message from a source node in a network to a plurality of destination nodes. Typically, a unique IP address is assigned to a predetermined group of communication nodes in the network. A message may then be delivered to that IP address and every node that is a part of the group is able to read the message.

To utilize IP multicasting during RAN operations in a RAN, a number of multicast groups may be formed and maintained in the network. Each of the multicast groups may be assigned a unique IP multicast address. An RRC may then transmit an RRM message as an IP multicast message to a corresponding multicast group when information is needed or being provided. The IP multicast message is sent via IP backbone 144.

Various procedures are defined within the Requests for Comments (RFCs) of the Internet Engineering Task Force (IETF) that may be used to perform various tasks associated with various embodiments of the present invention. For example, RFCs exist for procedures to create multicast groups, to allow entities (e.g., base stations, PCs, etc.) to join and leave multicast groups, to perform packet exchanges within multicast groups, and so on. An example is RFC 966 (1985). These procedures may be used in various embodiments of the invention. Other procedures may alternatively be used. In at least one embodiment of the invention, the base stations in a multicast group use a shortest path tree based multicast distribution tree for the transfer of multicast messages. By using a shortest path tree based multicast distribution tree, reduced delays are incurred in the transfer of messages between the multicast members.

Thus, the communications within and between RANs 300, 302 and 400 and their various components may be handled as unicast transmissions or may be handled as IP multicasts.

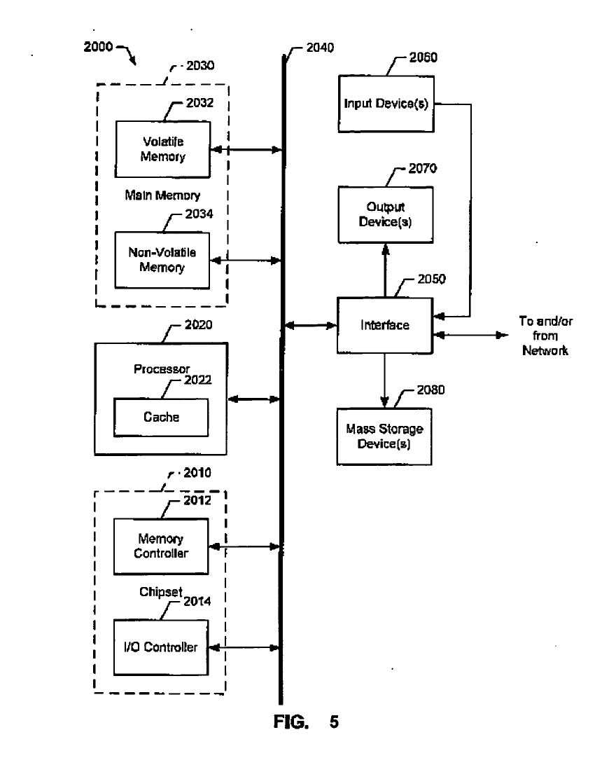

FIG. 5 is a block diagram of an example processor system 2000 adapted to implement the methods and apparatus disclosed herein, in accordance with various embodiments. The processor system 2000 may be a desktop computer, a laptop computer, a handheld computer, a tablet computer, a PDA, a server, an Internet appliance, and/or any other type of computing device.

The processor system 2000 illustrated in FIG. 5 may include a chipset 2010, which includes a memory controller 2012 and an input/output (I/O) controller 2014. The chipset 2010 may provide memory and I/O management functions as well as a plurality of general purpose and/or special purpose registers, timers, etc. that are accessible or used by a processor 2020. The processor 2020 may be implemented using one or more processors, Wireless Personal Area Network (WPAN) components, Wireless Local Area Network (WLAN) components, Wireless Metropolitan Area Network (WMAN) components, Wireless Wide Area Network (WWAN) components, and/or other suitable processing components. For example, the processor 2020 may be implemented using one or more of the Intel® Core™ technology, Intel® Pentium® technology, the Intel® Itanium® technology, the Intel® Centrino™ technology, the Intel® Core™ Duo technology, the Intel® Xeon™ technology, and/or the Intel® XScale® technology. In the alternative, other processing technology may be used to implement the processor 2020. The processor 2020 may include a cache 2022, which may be implemented using a first-level unified cache (L1), a second-level unified cache (L2), a third-level unified cache (L3), and/or any other suitable structures to store data.

The memory controller 2012 may perform functions that enable the processor 2020 to access and communicate with a main memory 2030 including a volatile memory 2032 and a non-volatile memory 2034 via a bus 2040. The volatile memory 2032 may be implemented by Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2034 may be implemented using flash memory, Read Only Memory (ROM), Electrically Erasable Programmable Read Only Memory (EEPROM), and/or any other desired type of memory device.

The processor system 2000 may also include an interface circuit 2050 that is coupled to the bus 2040. The interface circuit 2050 may be implemented using any type of interface standard such as an Ethernet interface, a universal serial bus (USB), a third generation input/output (3GIO) interface, and/or any other suitable type of interface.

One or more input devices 2060 may be connected to the interface circuit 2050. The input device(s) 2060 permit an individual to enter data and commands into the processor 2020. For example, the input device(s) 2060 may be implemented by a keyboard, a mouse, a touch-sensitive display, a track pad, a track ball, an isopoint, and/or a voice recognition system.

One or more output devices 2070 may also be connected to the interface circuit 2050. For example, the output device(s) 2070 may be implemented by display devices (e.g., a light emitting display (LED), a liquid crystal display (LCD), a cathode ray tube (CRT) display, a printer and/or speakers). The interface circuit 2050 may include, among other things, a graphics driver card.

The processor system 2000 may also include one or more mass storage devices 2080 to store software and data. Examples of such mass storage device(s) 2080 include floppy disks and drives, hard disk drives, compact disks and drives, and digital versatile disks (DVD) and drives.

The interface circuit 2050 may also include a communication device such as a modem or a network interface card to facilitate exchange of data with external computers via a network. The communication link between the processor system 2000 and the network may be any type of network connection such as an Ethernet connection, a digital subscriber line (DSL), a telephone line, a cellular telephone system, a coaxial cable, etc.

Access to the input device(s) 2060, the output device(s) 2070, the mass storage device(s) 2080 and/or the network may be controlled by the I/O controller 2014. In particular, the I/O controller 2014 may perform functions that enable the processor 2020 to communicate with the input device(s) 2060, the output device(s) 2070, the mass storage device(s) 2080 and/or the network via the bus 2040 and the interface circuit 2050.

While the components shown in FIG. 5 are depicted as separate blocks within the processor system 2000, the functions performed by some of these blocks may be integrated within a single semiconductor circuit or may be implemented using two or more separate integrated circuits. For example, although the memory controller 2012 and the I/O controller 2014 are depicted as separate blocks within the chipset 2010, the memory controller 2012 and the I/O controller 2014 may be integrated within a single semiconductor circuit.

Although certain embodiments have been illustrated and described herein for purposes of description of the preferred embodiment, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A method comprising:
receiving a first radio resource management (RRM) message at a radio resource controller (RRC) located within a base station of a first network comprising the RRC, an RRM relay and a plurality of radio resource agents (RRAs), the first RRM message being received from the RRM relay and indicating that management information is needed within a network; and
transmitting a response from the RRC to the RRM relay, in a form of an RRM message, the response comprising either the management information or a request for information related to the management information.

2. The method of claim 1, wherein the information is needed with the first network.

3. The method of claim 1, wherein the information is needed with a second network.

4. The method of claim 1, wherein the management information comprises capacity of at least one of the RRAs.

5. The method of claim 4, wherein the information related to the management information comprises radio resources used by at least one mobile client device within the network.

6. The method of claim 1, wherein the response is in the form of an Internet Protocol (IP) multicast to a multicast group that includes at least some of the RRAs.

7. The method of claim 6, further comprising receiving additional RRM messages, by the RRC, comprising the information related to the management information and transmitting further RRM messages comprising the information related to the management information as an IP multicast to the multicast group.

8. The method of claim 1, wherein the response is in the form of a unicast transmission.

9. The method of claim 1, wherein the first RRM message is received unsolicited.

10. The method of claim 1, wherein the first RRM message is received in response to a prior solicitation by the RRC.

11. An apparatus comprising:
a radio resource controller (RRC) including a transceiver, the transceiver being adapted to transmit and receive management information for a network, in a form of a radio resource management (RRM) message, to and from a radio resource agent (RRA) and an RRM relay.

12. The apparatus of claim 11, wherein the transceiver is adapted to transmit and receive further RRM messages comprising information related to the management information.

13. The apparatus of claim 11, wherein the management information comprises capacity of at least one RRA.

14. The apparatus of claim 13, wherein the transceiver is also adapted to receive and transmit RRM messages comprising information related to the management information that comprises radio resources used by at least one mobile client device within the network and transmit further RRM messages comprising the information related to the management information.

15. The apparatus of claim 11 wherein the transceiver is further adapted to transmit the information in the form of an RRM message as an Internet Protocol (IP) multicast for transmission to an IP multicast group.

16. The apparatus of claim 15, wherein the transceiver is adapted to receive another RRM message comprising information related to the management information from members of the IP multicast group.

17. The apparatus of claim 11, wherein the transceiver is adapted to transmit the information in a form of an RRM message as a unicast transmission.

18. A system comprising:
an omnidirectional antenna; and
a processor coupled to the antenna and adapted to enable a radio resource controller (RRC) to transmit and receive management information, in a form of a radio resource management (RRM) message, to and from a radio resource agent and a radio resource management relay.

19. The system of claim 18, wherein the management information comprises capacity of at least one RRA.

20. The system of claim 18, wherein the processor is also adapted to enable the RRC to receive an RRM message comprising information related to the management information that comprises radio resources used by at least one mobile client device within the network and transmit another RRM message comprising the information related to the management information.

21. An article of manufacture comprising:
a storage medium; and
a plurality of programming instructions designed to enable a radio resource controller (RRC) within a network to transmit management information to a radio resource management (RRM) relay, and to enable the RRC to transmit, to the RRM relay, a request for information related to the management information.

22. The article of manufacture of claim 21, wherein the programming instructions are also designed to enable the RRC to receive, from the RRM relay, an RRM message comprising management information or information related to the management information.

23. The article of manufacture of claim 22, wherein the programming instructions are further designed to enable the RRC to transmit the management information and information related to the management information in a form of RRM messages as an Internet Protocol (IP) multicast for transmission to an IP multicast group.

24. The article of manufacture of claim 22, wherein the programming instructions are further designed to enable the RRC to transmit the management information and information related to the management information in a form of RRM messages as unicast transmissions.
